(19) United States
(12) Patent Application Publication
(10) Pub. No.: US 2002/0059333 A1
(43) Pub. Date: May 16, 2002

(54) Display text modification for link data items

(76) Inventor: Jason Tribbeck, Surrey (GB)

Correspondence Address: NIXON & VANDERHYE P.C., 8th Floor, 1100 North Glebe Road, Arlington, VA, 22201-4714, US

(21) Appl. No.: 09/837,541

(22) Filed: Apr. 19, 2001

Related U.S. Application Data
(63) Continuation of application No. PCT/GB00/01534, filed on Apr. 19, 2000.

(30) Foreign Application Priority Data
May 7, 1999 (GB) 9910683.3
May 7, 1999 (GB) 9910684.1
May 7, 1999 (GB) 9910679.1
May 7, 1999 (GB) 9910682.5
May 7, 1999 (GB) 9910685.8

(51) Int. Cl. G06F 15/16

(52) U.S. Cl. 707/500; 709/203

(57) ABSTRACT

A data processing system for accessing documents including hypertext links (80) with an associated initial display text is provided with a mechanism for applying one or more predetermined rules (94) to the initial displayed text to determine whether or not that initial displayed text has characteristics indicative of being insufficiently readable by a user. Upon detection of such characteristics, the system responds by replacing (100) the initial display text with further text selected in dependence upon the link data item.

This invention relates to data processing systems. More particularly, this invention relates to data processing systems processing data files representing documents and including link data items specifying linked locations within one document or another document.

It is known to provide data files representing documents with embedded link data items in the form of hypertext links. This is the normal way in which information is presented and manipulated on the internet world wide web.

The hypertext links within an internet document allow a user to select that link, e.g. initiating a mouse click over it, and so jump to a linked location in that same document, or more typically, within another document. In order that the user can successfully navigate through the content provided using the hypertext links, it is important that each link should clearly convey to the user what is the associated linked location. This may be done using descriptive text, an associated image (e.g. a thumbnail image) or with some other graphical or textual representation.

An overwhelming majority of the existing material available on the internet via the world wide web has been generated with the intention of display and manipulation using a conventional personal computer. However, there is a desire and need to allow access to this pre-existing material via different devices with different processing and display capabilities. An example of such a different access device is a mobile telephone. A mobile telephone typically has a smaller display of a lower resolution than that of a personal computer. In addition, the available transmission bandwidth to the mobile telephone is typically lower than that which may be available to a personal computer. In order to cope with the different and often reduced capabilities of such alternative devices for accessing internet world wide web pages, it is possible to modify the pages being accessed to make them more suitable for such alternative display devices. As an example, graphical images may be stripped out of the pages in order to reduce the transmission bandwidth constraints.

Viewed from one aspect the present invention provides a method of processing a data file representing a document, said data file including at least one link data item specifying a linked location within said document or another document. said method comprising the steps of:

(i) detecting initial display text associated with said link data item for display on a display device to at least partially represent said link data item to a user when said document is displayed;

(ii) applying one or more predetermined rules to said initial display text to detect one or more characteristics indicative of said initial display text being insufficiently readable by said user; and

(iii) upon detection of said one or more characteristics indicative of said initial display text being insufficiently readable by said user, then replacing some or all of said initial display text with further text selected in dependence upon said link data item to provide a modified display text for display on said display device.

The present invention recognises that the initial display text associated with a link data item by the author of the document may not be sufficiently specific itself to identify the link. Accordingly, the invention provides a mechanism that applies one or more predetermined rules to the initial display text to detect characteristics indicative of the initial display text being insufficiently readable and to act upon such detection to replace some or all of the initial display text with further text selected in dependence upon the link data item. This technique is particularly useful when the document has been modified from its original form as some of the content intended by the author to identify a link may have been removed (e.g. an image identifying a link). The further text added is dependent upon the link data item and accordingly has a good chance of increasing the comprehensibility of the link to a user.

The further text may take various different forms and be selected in various different ways. However, particularly preferred embodiments of the invention are ones in which said further text includes one or more of;

(i) a document title for said linked location identified by said link data item; and

(ii) text selected from a dictionary in dependence upon keywords identified within said link data item;

(iii) a word produced by truncating a computer file name including a computer file type extension by removing said computer file type extension; and

(iv) text selected in dependence upon category data associated with said link data item.

It will be appreciated that whilst the further text could be added to the initial text, it is found to produce better results if the further text completely replaces the initial displayed text.

The further text selected in dependence upon the link data item may not always be an improvement over the initial displayed text. Accordingly, in preferred embodiments of the invention the method further comprises the steps of:

(i) applying said one or more predetermined rules to said modified display text to detect one or more characteristics indicative of said modified display text being insufficiently readable by said user; and

(ii) upon detection of said one or more characteristics indicative of said modified display text being insufficiently readable by said user, then reverting to said initial display text.

In this way, if the further text has not produced an improvement in the readability of the displayed text, then the system may revert to the initial displayed text.

The predetermined rules by which the system text characteristics indicative of a low level of readability could take a wide variety of forms. However, a particularly preferred set of rules that may be used individually, but preferably in at least partial combination is:

(i) the number of underscore characters within said initial display text is greater than the number of space characters within said initial display text;

(ii) the initial display text is less than a minimum threshold number of characters in length;

(iii) the initial display text is greater than a maximum threshold number of characters in length;

(iv) the average number of characters per word in said initial display text is greater than a maximum threshold average word length;

(v) the initial display text contains words that include capital letters after lower case letters; and

(vi) the initial display text contains words not found in an associated dictionary of words.

Whilst the present invention could be used on a stand alone computer, it is particularly useful when the data file representing the document is retrieved from a source computer server via a computer network. In this context, a proxy server disposed within the computer network between the source computer server and a client computer can be particularly useful since the proxy server can conduct the detecting applying and replacing steps using its usually higher processing and storage capabilities prior to passing the data file representing the document to the client computer which has display capabilities different from those for which the document was intended or said document is display independent (e.g. XML). This is particularly the case when the client computer is in the form of a wireless mobile device.

Viewed from another aspect the present invention provides apparatus for processing a data file representing a document, said data file including at least one link data item specifying a linked location within said document or another document. said apparatus comprising processing logic for performing the steps of:

(i) detecting initial display text associated with said link data item for display on a display device to at least partially represent said link data item to a user when said document is displayed;

(ii) applying one or more predetermined rules to said initial display text to detect one or more characteristics indicative of said initial display text being insufficiently readable by said user; and

(iii) upon detection of said one or more characteristics indicative of said initial display text being insufficiently readable by said user, then replacing some or all of said initial display text with further text selected in dependence upon said link data item to provide a modified display text for display on said display device.

An embodiment of the invention will now be described, by way of example only, with reference to the accompanying drawings in which:

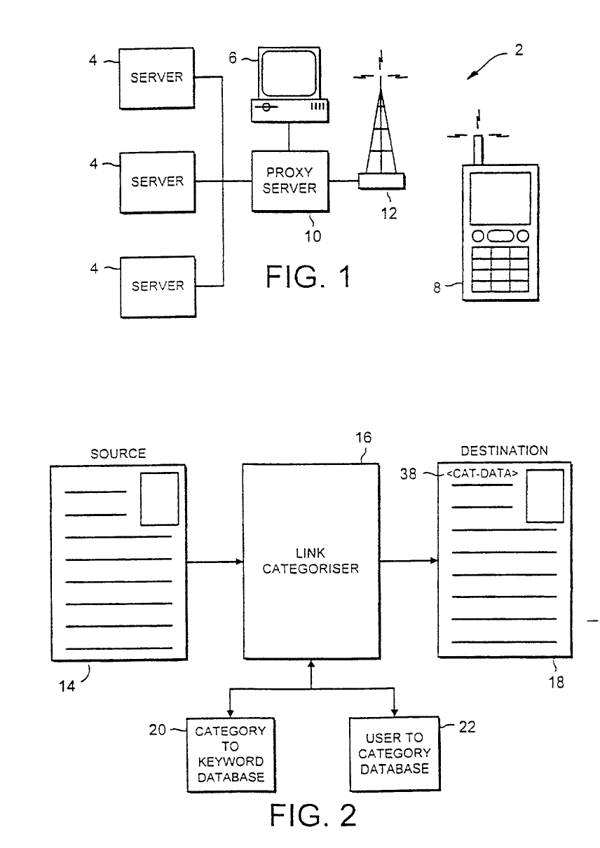

FIG. 1 schematically illustrates a computer network;

FIG. 2 schematically illustrates a system for adding categorising data to a data file representing a document;

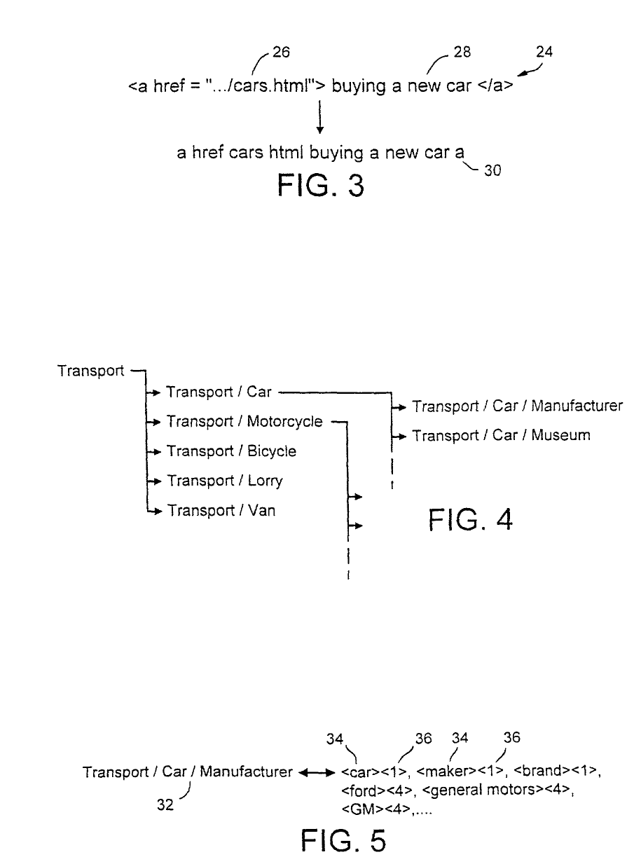

FIG. 3 illustrates a link data item and associated keywords;

FIG. 4 schematically illustrates a hierarchical category database;

FIG. 5 illustrates a category data entry;

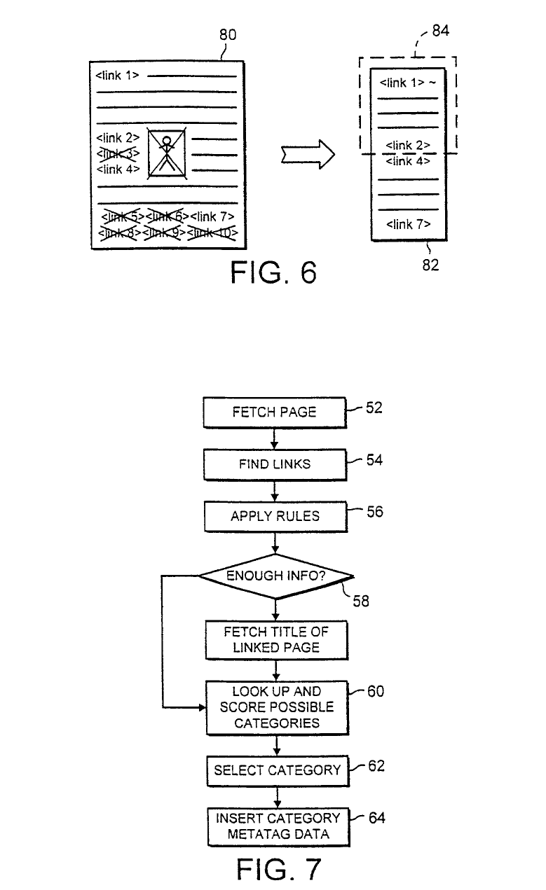

FIG. 6 illustrates how a web page may be modified using category data to filter out links known to be unwanted of less wanted by a user;

FIG. 7 is a flow diagram illustrating the addition of category data to a document;

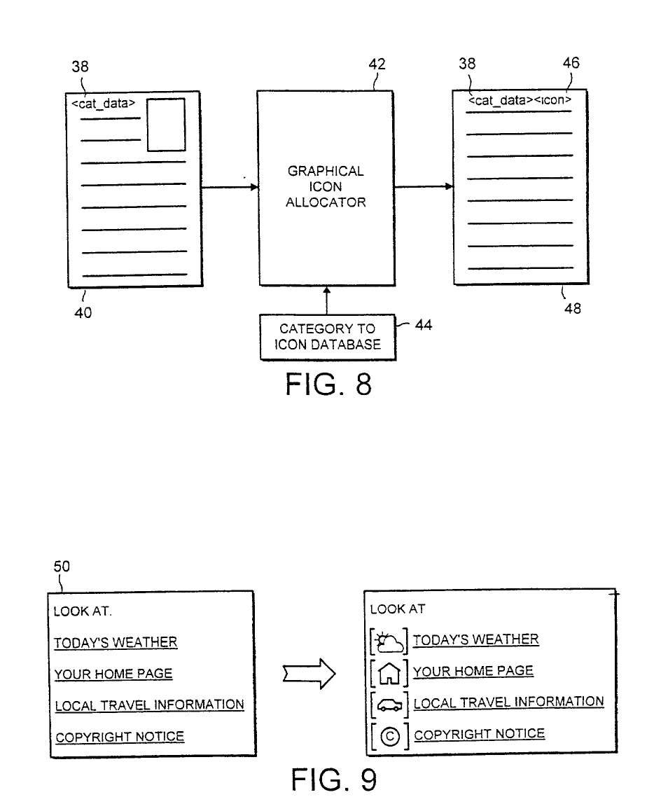

FIG. 8 schematically illustrates a system for adding output graphical data to a document;

FIG. 9 illustrates a low resolution display device showing a document before and after addition of icons in accordance with category data;

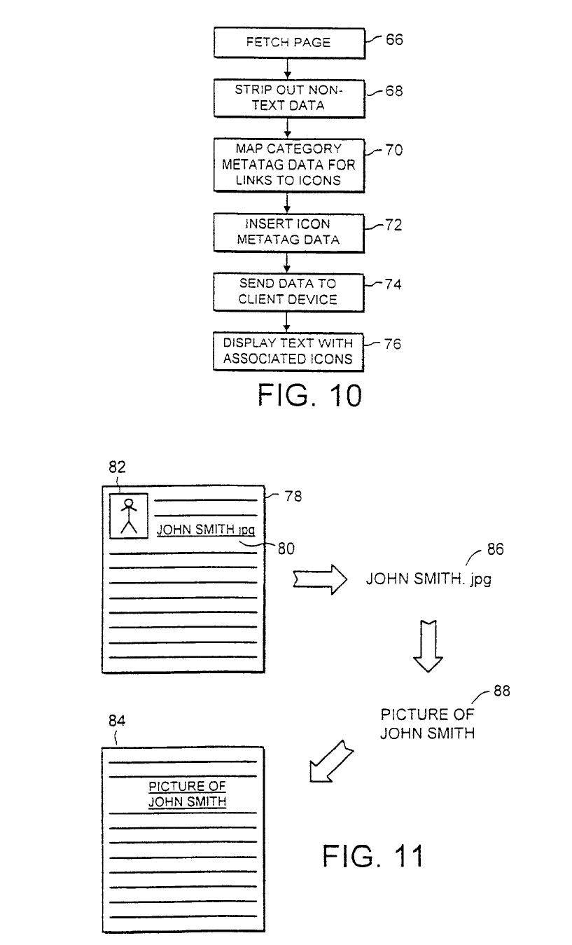

FIG. 10 is a flow diagram illustrating the addition of output graphical data items in association with link data within a document;

FIG. 11 schematically illustrates modifying display text associated with a link data item into a more readable form;

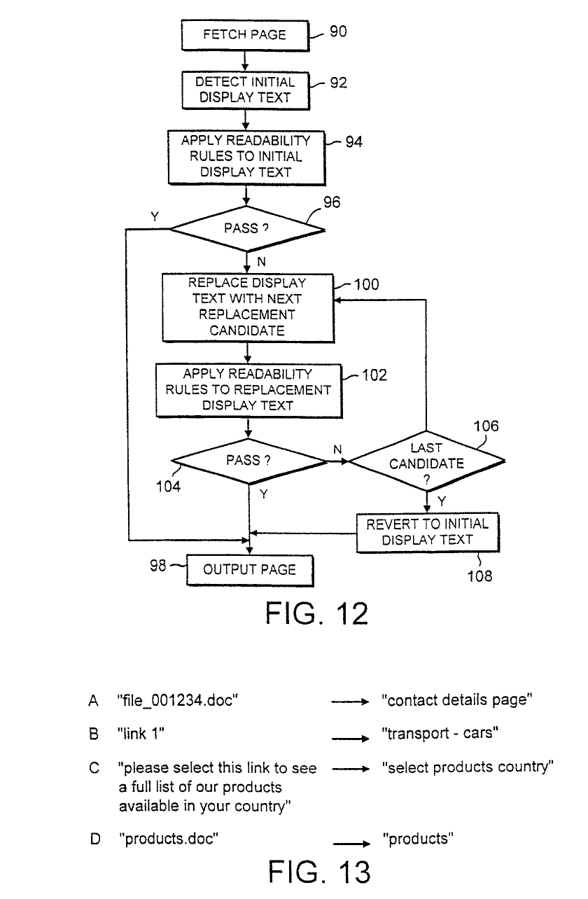

FIG. 12 shows a flow diagram illustrating the process of modifying display text into a more readable form;

FIG. 13 illustrates various examples of text modifications that may be performed;

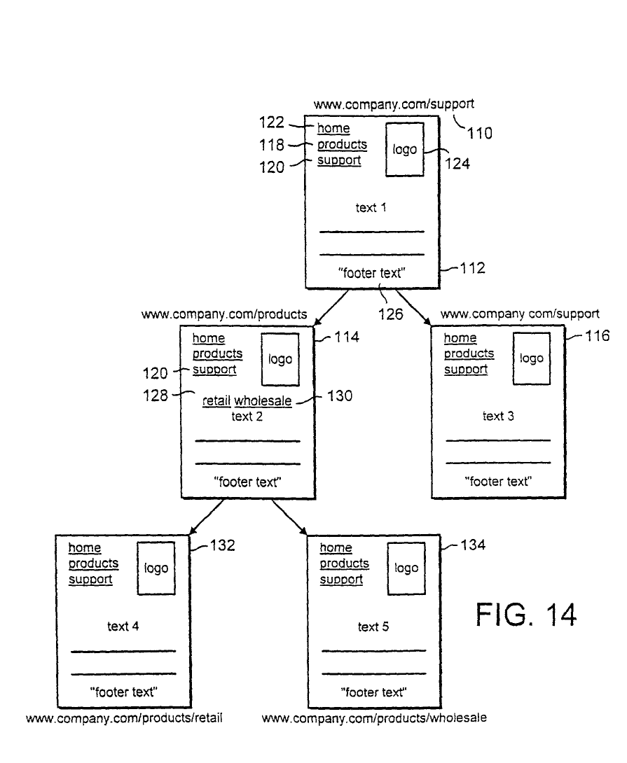

FIG. 14 illustrates an unmodified hierarchy of documents including repeated components;

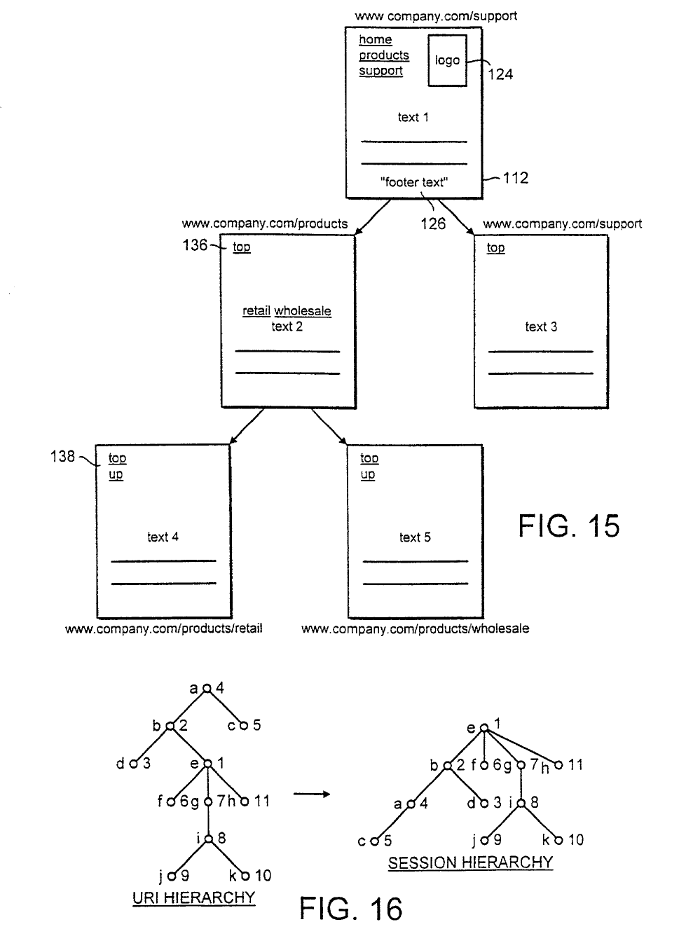

FIG. 15 illustrates a modified form of the hierarchy of FIG. 14 in which repeated components have been removed;

FIG. 16 illustrates the comparison between a universal resource identifier based hierarchy and a session based hierarchy;

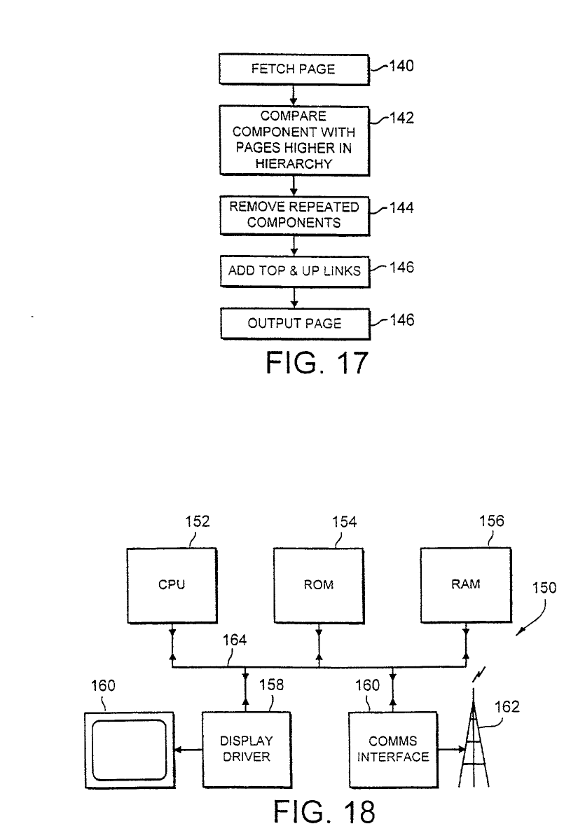

FIG. 17 is a flow diagram showing the process for removing repeated components within a hierarchy; and

FIG. 18 schematically illustrates a data processing apparatus that may serve as a client computer

FIG. 1 illustrates a computer network 2. This computer network 2 may be a portion of the internet in which internet web pages in the form of HTML data files are transmitted between source servers 4 and client computers 6, 8. A proxy server 10 is disposed between the source servers 4 and the client computers 6, 8. The client computer may be a normal desktop computer 6 for which the internet web pages are primarily designed and intended. The client computer may also be in the form of an internet-enabled mobile telephone 8 connected via a radio link 12 to the computer network 2.

The mobile phone 8 connects via the proxy server 10, and the proxy server 10 may detect (e.g. via user id and password details) that the link from the mobile phone 8 as a client computer is to a device having a smaller and less capable display than a full desktop computer 6. Accordingly, the proxy server 10 is able to perform additional processing steps on the internet web pages fetched from the source servers 4 before they are passed to the mobile telephone 8 so that they can be adapted to be more usefully displayed on the mobile telephone 8. It will be appreciated that if the processing capabilities of the mobile telephone 8 were greater and the radio bandwidth sufficient, then the full internet web pages could be transmitted to the mobile telephone 8, which may then conduct its own processing of those pages to put them into a form more suitable for display on its smaller display output.

FIG. 2 schematically illustrates how a data file representing a source document 14 may be processed by a link categoriser 16 to generate an output document 18 that has category data added to it. It will be appreciated that the link categoriser 16 will typically take the form of a general purpose computer executing software written to perform the function of adding the category data to the documents. The link categoriser 16 uses a category-to-keyword database 20 which enables keywords identified within the source document 14 to be mapped to appropriate catergories. The category-to-keyword database 20 can be in the form of a hierarchical database with each category data entry having the keywords associated with that category data entry related thereto and with score values for each associated keyword. The link categoriser 16 also uses a user-to-category database 22 which enables the link categoriser to perform other functions, such as modifying the source document in a way that removes or adds data known to be or particular interest the user concerned.

FIG. 3 illustrates a link data item 24 that is typically embedded within a HTML document. The link data item 24 includes a universal resource identifier 26 and display text 28. If display text 28 is present, then this is what will be displayed as the hypertext link in the document. If display text 28 is not present, then the universal resource identifier 26 will be displayed.

The keywords within the link data item 24 are identified by processing the link data item 24 by removing all punctuation and replacing this with spaces. The resulting stream of keywords 30 can then be input to the keyword-to-category matching database 20. The category-to-keyword database 20 can be arranged as a relational database making the analysis of the keywords sufficiently rapid to be performed in real time by the proxy server 10.

FIG. 4 schematically illustrates the hierarchical nature of the category database 20. In particular, a category such as “Transport” can be broken down into a number of sub-categories such as “Car”, “Motorcycle”, “Bicycle”, “Lorry”, and “Van”. Each of these sub-categories can be further broken down as illustrated. The hierarchy could have a varying depth depending upon the required degree of specificity traded off against the processing and data storage requirements as well as the likelihood of a highly specific categorisation in fact being correct.

FIG. 5 schematically illustrates a particular category data entry within the category-to-keyword database 20. In this case, the category data 32 is associated with a sequence of keywords 34 each having an associated score value 36. The keywords 30 with the link data item 24 are matched against the keywords 34 and the score values 36 for each match of a category data entry 32 added together. The category data entry 32 having the highest score is deemed to be the match.

Returning to FIG. 2, when the category data entry 32 that produces the best match has been identified, then category data 38 in the form of a metatag is inserted into the document 18 in association with the link data item 24 that has been analysed. The category data 18 thus gives a representation of the subject matter to which the link data item 24 relates. This information is highly useful to other processes performed by the proxy server 10. In particular, the proxy server 10 might automatically insert a graphical item before each hypertext link to assist in faster recognition of links of interest. The proxy server 10 could filter out categories that are known to be unsuitable or undesired for the user, for example if the reader is known within the user-to-category database 22 to not want information concerning cars. The proxy server 10 can also record information regarding the categories of links followed by a user while viewing hypertext documents and so assemble a profile of the user's interest such that other material of possible interest to the user, such as targeted advertising, may be presented to the user. Another use that can be made of such user profiling information is pre-fetching of information relevant to the user's interests. Using pre-fetching, the proxy server 10 may automatically collect and store information that the user is likely to want to view before they request it. If they do then request this information, it can be delivered more quickly. If they do not request the information, then the information can be discarded.

FIG. 6 shows how an original web page 80 containing ten hypertext links can be modified into a page 82 more suited to display using a smaller display window 84 by the removal of hypertext links detected as either not wanted or less likely to be wanted by a user. This is done by comparing the category data 38 associated with each link with the user preference data stored in the user to category database 22. The user to category database 22 can contain preference data obtained by the user specifying categories of link in which they are not interested and do not wish to display. Alternatively or additionally, the user to category database 22 can be automatically built up by the proxy server 10 keeping a record of the categories of the links that a user follows, e.g. by dynamically user profiling the categories of interest. Thus, categories stated or observed to be of little interest to a user can be removed from the page 82 so making better use of the limited bandwidth and display resources. This sort of content filtering may also be used to block material, such as by a parent wishing to prevent access to unsuitable material by a child.

FIG. 7 is a flow diagram illustrating the process of adding category data to a source document. At step 52, the source document is fetched via the network link from the source server 4. The proxy server 10 at step 54 processes the source document to identify the link data items 24 within it and isolate the keyword data within those link data items 24. At steps 56 and 58, the proxy server applies a series of rules to the keywords identified within the link data item 24 to determine whether they are sufficiently specific to enable a proper categorisation to be made. An example of the rules applied are as follows:

1) Initially everything is neat, i.e. is initialized in a state termed “neat”;

2) It is ruled as being not neat it the length of the text is greater than 10 AND the length to space ratio is greater than 10:1;

3) It is ruled as being neat if the text is “entertainment”;

4) It is ruled as being not neat if the text is “image” followed by a number;

5) It is ruled as being not neat if the length of the text is less than 4 characters;

6) It is ruled as being not neat if the number of underscores exceeds the number of spaces;

7) It is ruled as being not neat if the text beings with “http://”;

8) It is ruled as being not neat if the text is enclosed with quotes;

9) It is ruled as being not neat if the text beings with “image map”;

10) It is ruled as being not neat if the text is “default”.

In addition, there are additional rules that may be added for specific geographical locations. e.g;

11) It is ruled as neat if the text contains “Island”;

12) It is ruled as neat if the text contains “Kanagawa-Ken”.

Both of these (and also some of the specific rules) may be added in a category such as ‘rules specific to sites’.

If sufficient information is present, then processing proceeds to step 60. If sufficient information is not present, then the proxy server 10 fetches the title data of the target location identified by the link data item 24 to derive additional keywords from that title data. The entire document indicated by the link data item need not be fetched. This contrasts to spidering in which the entire document pointed to by a link data item is fetched and analysed.

At step 60, the proxy server/link catergoriser 16 looks up the keywords identified within the category-to-keyword database 20 and scores each possible category. At step 62, the category with the highest score is selected to be associated with the link data item 24. At step 64, a metadata tag identifying the category selected at step 62 is inserted into the document in association with the link data item 24.

FIG. 8 schematically illustrates a system for modifying the graphical data contents of a document. A source document 40 is accessed from a source server 4 via an internet link. The source document 40 is in the form of a HTML document representing an internet web page. The source document 40 may contain GIF files. JPEG files and bitmap files as part of its source graphical data content. The source document 40 includes category data 38 classifying the link data items 24 as added by the processing discussed above.

A graphical icon allocator 42 receives the source document 40 and removes all or some of the source graphical data items. The graphical icon allocator 42 then accesses a category-to-icon database 44 where icons suitable for association with each link data item 24 within the source document 40 are identified using the category data 38 embedded within the source document 40. When an output graphical data item has been identified from the category-to-icon database 44, then data identifying this icon 46 is inserted as a metatag into the output document 48. The data identifying the output graphical data item 46 may be merely an identifier for an icon which is built into the known display device 8, or alternatively it may be data giving sufficient information to specify the appearance of the icon without this already being embedded within the display device 8.

It will be appreciated that the graphical icon allocator 42 will typically take the form of software operating on a general purpose computer, such as the proxy server 10. If the processing capabilities of the client computer 8 are sufficient and sufficient bandwidth is available, then the source document 40 may be transmitted to the client computer 8 in its entirety and the processing illustrated in FIG. 6 performed wholly within the client computer 8.

FIG. 9 illustrates a small low resolution display device 50, such as the small LCD display of a mobile telephone 8. The left hand portion of FIG. 7 illustrates a text-only web page showing a series of hypertext links with all of the graphical data from the source page removed. The usability of such a display is poor compared to the original source document 40 as users derive considerable information from the graphical data content of a page.

Using the present invention, the links within the page can be categorised and then appropriate icons associated with each link. These icons can be built into the mobile telephone 8 itself such that they do not need to be transmitted to the client computer in their entirety. A code identifying a particular built-in icon can merely be added as the data 46 in the output document 48.

FIG. 10 is a flow diagram illustrating the processing of graphical data items. At step 66, the proxy server 10 fetches a source document 40. At step 68, the proxy server/graphical icon allocator 42 removes all non-text data from the source document 40. At step 70, the graphical icon allocator maps the category data 38 to icons to be associated with the link data item 24 using the category-to-icon database 44. At step 72, the icon identifying data is inserted as a metatag 46 within the output document 48. At step 74, the resulting output document 48 including text data and associated icon data is transmitted to the client computer 8. At step 76, the client computer 8 processes the received document and displays the text with its associated icons next to the link data items. The icons can be built-in icons within the client computer 8 itself.

FIG. 11 illustrates a source document 78 in the form of an internet web page intended by the author to be displayed and manipulated using a conventional personal computer. Within the document 78 there is a link data item 80 in the form of a hypertext link to a large image file. A small thumbnail representation 82 of the full image file is also shown. When a user accesses this web page 78 on a conventional personal computer, then the thumbnail representation 82 in combination with the display text of the link 80 gives sufficient information for the user to understand the link being made. However, if the web page 78 is modified to produce a modified page 84 in which graphical data has been removed, then the initial display text 86 associated with the link 80 may not be sufficient to enable a user to properly understand the connection being made.

The system identifies the links within the web page 78 and performs tests upon the initial display text associated with each link to determine characteristics indicative of insufficient readability. In the case of the initial display text 86 shown in FIG. 11, then this may fail the test of comprising too many characters within a word or of including a capital letter following a lower case letter within the middle of a word. The initial display text 86 having been identified as not sufficiently readable, the title 88 of the page to which the link relates is accessed and this title used as further text in place of the initial display text 86. The title 88 is itself subject to an assessment of its readability and only if it passes this determination does it remain as a replacement for the initial display text 86. If the further text 88 fails the readability test, then the initial display text is reverted to for the link 80.

The above technique uses a system of computer software through which users are required to fetch hypertext documents that they wish to read. Typically this is in the form of an intermediate “proxy server”, but a stand-alone mode of operation can also be envisaged. The system processes the hypertext pages as they are transferred from the storage location to the reader. After identifying the links in the hypertext document, the textual part of the hypertext link (i.e. the text which the user would select in order to go to the linked document) is checked to see if it is readable. This can be done in a number of ways, including (but not limited to):

the number of underscores is greater than the number of spaces;

the text is less than a certain number of characters long;

the text is longer than a certain number of characters long;

the average number of characters per word is greater than a certain limit;

the text contains words which have capital letters after lowercase letters in the same word (e.g. gooSE);

the text contains words which are not in a dictionary;

A combination of the above rules can be used to score the link in terms of readability, and if the score is above a threshold, then an alternative to the text is sought. This can also be done in several ways, including (but not limited to):

fetching the linked hypertext document and retrieving the document's title (should one exist), or the first line of the text in the document;

substituting the text with different text from a dictionary (stored in a file coupled to the proxy server e.g. a keyword to further text mapping);

replacing with the title of the current document (should one exist);

using a filename with its file type suffix removed.

If the further text that is to replace the initial display text is deemed more unreadable then the initial display text, then the initial display text is kept in place, and either no substitution takes place, or an alternative substitution is used.

FIG. 12 shows a flow diagram illustrating the technique of improving the readability of the display text associated with links.

At step 90 a page to be accessed is fetched from a remote computer server. At step 92 the fetched page is searched to detect link data items (hypertext links) and the initial display text associated with these links is determined. At step 94 the readability rules described above are applied to the initial display text of each link. At step 96 a determination is made as to whether or not the initial displayed text passes the readability rules. If the initial display text does pass the readability rules, then the process proceeds to step 98 where the output page is generated.

If the initial display text does not pass the readability rules at step 96, then step 100 is used to replace the text with further text derived in dependence upon the link item data, such as by using the replacements described above. These candidate replacements can be applied in turn with each candidate replacement being tested by steps 102 and 104 to determine whether or not it passes the readability test. If it does pass the readability test at step 104, then the replacement candidate is used as the further text to replace the initial display text within the link data item and an output page including this further text is produced at step 98. If the candidate replacement text does not pass the readability text, then the next candidate replacement text will be tried providing step 106 does not determine that all the candidates have been exhausted. If step 106 does determine that all the candidate replacement text have been exhausted, then step 108 reverts to the initial display text and the output page is produced using this initial display text at step 98.

FIG. 13 schematically illustrates how some initial display text may be modified into forms more readily readable. In example A, a file name containing a mixture of numbers and underscore characters and exceeding a predetermined length is replaced by the title of the page to which it points. In example B, an initial display text that is too short to be useful is replaced with category data associated with the link and derived as described above. In example C, an initial display text that is too long to be usefully displayed on a mobile telephone is replaced by a text that uses keywords selected from the initial longer text. Finally, in example D, a file name is replaced by the file name minus its file type suffix.

As previously described, it will be appreciated that the processing described above to improve the readability of the display text associated with a link data item may be performed either on a proxy server using the superior processing and storage capabilities of that proxy server, or upon the client device itself. As the client devices improve in their capability, it will be natural for more processing to take place upon the client device and so remove the need for the connection to have to be made through a particular proxy server.

FIG. 14 schematically illustrates an internet web site in the form of a hierarchy of documents. Each page has an associated universal resource identifier 110 with a form similar to a directory/subdirectory structure. The hierarchy illustrated starts with a company home page 112 and progresses to a products page 114 and a support page 116 via respective hypertext links 118 and 120. The hypertext links 118 and 120 together with a home page link 122 form a navigation bar that appears on all of the pages of the web site. A company logo 124 and a standard footer text 126 also appear on all pages of the web site.

The product page 114 includes two further hypertext links 128 and 130 that respectively point to pages 132 and 134 giving details of retail and wholesale products. Each of the pages 112, 114, 116, 132 and 134 also includes its own unique text.

It will be appreciated that when processing and bandwidth resources as well as display device resources are limited, then the repeated transmission, processing and display of items such as the company logo 124 and the footer text 126 represent a significant overhead. Assuming that a user enters the site at page 112, then they are initially presented with the opportunity to progress to the support page. If instead the user progresses to the products page 114, then it is reasonable to assume that they are not interested in support. Accordingly, it is wasteful to display the link 120 to the support page 116 on the product page 114 as well as on the home page 112.

FIG. 15 illustrates the web site shown in FIG. 14 but this time modified such that repeated components lower down in the hierarchy are removed, i.e. in this arrangement components appear upon their first occurrence when moving down the hierarchy but are thereafter removed. As an example, the company logo 124 appears on the home page 112, but does not appear on any of the pages lower in the hierarchy. Similarly the footer text 126 appears only on the home page 112 and has been removed from the lower pages. The links 118, 120 and 122 that form the navigation bar appear only on the home page 112. On the lower pages, a link 136 is added linking to the top page in the hierarchy. Where there is a page above the current page that is act the top page, then an unlink 138 is also added.

It will be seen from FIG. 15 that the content of the pages below the home page 112 has been significantly reduced so enabling them to be more rapidly transmitted to a client computer and conveniently and rapidly manipulated on that client computer. Nevertheless, all of the content of the original web site illustrated in FIG. 14 is present within the modified web site shown on FIG. 15 at some point within that web site.

FIG. 16 schematically illustrates how a web site may be placed into a hierarchy based upon the universal resource indicators as compared to a session hierarchy. On the left hand side of FIG. 16 is shown a hierarchy derived from the universal resource identifiers. The letters next to each node indicate a unique page The vertical position within the illustrated hierarchy denotes the position within the hierarchy. The numbers next to each node represent the order in which the pages are accessed during a user session. With the hierarchy based upon the universal resource identifier, page a is at the top of the hierarchy and page e is towards the centre. Compared to the universal resource identifier hierarchy, the session hierarchy illustrated in the right hand portion of FIG. 16 shows a hierarchy in which the first pages to be accessed are disposed higher within the hierarchy. Accordingly, since the first page accessed (e.g. through a bookmark) was page e, this is at the top of the hierarchy. A user may subsequently traverse the entire web site in the order shown by the numbers. The pages are arranged in the session hierarchy according to these numbers with pages at the same horizontal level indicating the same position within the hierarchy.

Hypertext documents are viewed in some sequence by each reader, moving from one to another by choosing “links” within each page. Where some information is presented on an early page and then ignored by the reader, it is reasonable to assume that they are not interested in it. Also, many modem hypertext document systems (sometimes called “web sites”) are designed in a hierarchical form. There may be pages to list the sections of the web site, and more to list each sub-section, followed by pages containing actual content. Either such a hierarchy or the historical tracking of a user's reading can be employed to assist the system predicting which pages a reader should already have read, if historical tracking information has not been recorded for them.

The present technique uses a system of computer software, through which users are required to fetch hypertext documents that they wish to read. Typically this is in the form of an intermediate “proxy server”, but a stand-alone mode of operation can also be envisaged. The system processes the hypertext pages as they are transferred from the storage location to the reader, removing parts, recording what it has found, and performing other tasks.

Once a hypertext document has been requested by the user and subsequently reviewed by the system, the system examines the hierarchy in which the page exists on the basis of the document's Uniform Resource Identifier (URI). This URI, or some similar information appropriate to the hypertext system being used, should uniquely identify the page and provide some information about the hierarchy in which it exists. The system fetches each page that is above the requested one in the hierarchy (sometimes called “parent” pages), and makes a note of discrete units of information on each page. It may only note links to other pages, but divisions of other information such as images and/or footnotes are also envisaged. If the reader's activity is being recorded, then pages they have already viewed may be considered instead of parent pages of the current document.

Once a note has been made of the information units on each page, those units that are present on parent pages are removed from the one requested by the reader. One or more new links are added to the current page to ensure that the reader has the opportunity to return to pages which do contain the links, should they wish to use them.

The advantage of this a procedure is that each document will be reduced to a more manageable size without removing significant information from it, and without requiring special preparation by the hypertext author. This is important for small devices that are technically limited and very different from the majority of readers for whom such authors write.

If the system is configured to work with a historical record of pages viewed by the reader, the oldest page considered as part of the link removal may either be the first page seen, the first seen within a certain time. e.g. ten minutes, or the N'th last page, perhaps the tenth last. It would not consider any page viewed after the first viewed of the current page (nor of course would it treat the current page as a previous one). This ensures that if the user goes “back” to a previous page, they will not lose all of the links on it.

FIG. 17 is a flow diagram illustrating the above process. At step 140 a target document is accessed. At step 142 the components making up that target document are compared with components known to be in document higher in the hierarchy than the target document. The contents of the components higher in the hierarchy may be determined by fetching those pages in dependence upon their universal resource identifier if they have not already been so fetched or may be determined on a user session basis as previously described.

At step 144 items within the target document found to be repeated components that are present in documents higher in the hierarchy are removed. At step 146 hypertext links to the top of the hierarchy and possibly also to one step up in the hierarchy are added. At step 148 the output page is generated.

FIG. 18 schematically illustrates a client data processing apparatus, such as a mobile telephone. The client device 150 will typically include a central processing unit 152, a read only memory 154, a random access memory 156, a display driver 158, a display 160, a communications interface 160 and an antenna 162. The central processing unit 152, the read only memory 154, the random access memory 156, the display driver 158 and the communications interface 160 are connected via a common bus 164. The read only memory 154 may form a computer program storage device holding a computer program for controlling the central processing unit 152 to carry out the processing described above where the processing is client based. The random access memory 156 will be used as working storage. The display 160 may be of a reduced size and resolution compared to a typical personal computer, e.g. it may be a low resolution LCD screen as typically found on present day mobile telephones, or just a small display per se. The communications interface 160 illustrated is a wireless interface that is linked to the proxy server 10 via the antenna 162.

1. A method of processing a data file representing a document, said data file including at least one link data item specifying a linked location within said document or another document, said method comprising the steps of:
(i) detecting initial display text associated with said link data item for display on a display device to at least partially represent said link data item to a user when said document is displayed;
(ii) applying one or more predetermined rules to said initial display text to detect one or more characteristics indicative of said initial display text being insufficiently readable by said user; and
(iii) upon detection of said one or more characteristics indicative of said initial display text being insufficiently readable by said user, then replacing some or all of said initial display text with further text selected in dependence upon said link data item to provide a modified display text for display on said display device.

2. A method as claimed in claim 1, wherein said further text includes one or more of:
(i) a document title for said linked location identified by said link data item; and
(ii) text selected from a dictionary in dependence upon keywords identified within said link data item;
(iii) a word produced by truncating a computer file name including a computer file type extension by removing said computer file type extension; and
(iv) text selected in dependence upon category data associated with said link data item.

3. A method as claimed in any one of claims 1 and 2, wherein said further text replaces said initial display text to form said modified display text.

4. A method as claimed in any one of claims 1, 2 and 3, further comprising the steps of:
(i) applying said one or more predetermined rules to said modified display text to detect one or more characteristics indicative of said modified display text being insufficiently readable by said user; and
(ii) upon detection of said one or more characteristics indicative of said modified display text being insufficiently readable by said user, then reverting to said initial display text.

5. A method as claimed in any one of the preceding claims, wherein said one or more predetermined rules include one or more of:
(i) the number of underscore characters within said initial display text is greater than the number of space characters within said initial display text;
(ii) the initial display text is less than a minimum threshold number of characters in length;
(iii) the initial display text is greater than a maximum threshold number of characters in length;
(iv) the average number of characters per word in said initial display text is greater than a maximum threshold average word length;
(v) the initial display text contains words that include capital letters after lower case letters; and
(vi) the initial display text contains words not found in an associated dictionary of words.

6. A method as claimed in any one of the preceding claims, wherein said data file is retrieved from a source computer server via a computer network.

7. A method as claimed in claim 6, wherein said steps of detecting, applying and replacing are performed by a proxy server disposed within said computer network between said source computer server and a client computer requesting said data file.

8. A method as claimed in claim 6, wherein said steps of detecting, applying and replacing are performed by a client computer which requests said data file from said source computer server.

9. A method as claimed in any one of claims 7 and 8, wherein said client computer has a user display with different display capabilities than those of a display for which said document is intended or said document is display independent.

10. A method as claimed in claim 9, wherein said client computer is a wireless mobile device.

11. Apparatus for processing a data file representing a document, said data file including at least one link data item specifying a linked location within said document or another document, said apparatus comprising processing logic for performing the steps of:
(i) detecting initial display text associated with said link data item for display on a display device to at least partially represent said link data item to a user when said document is displayed;
(ii) applying one or more predetermined rules to said initial display text to detect one or more characteristics indicative of said initial display text being insufficiently readable by said user; and
(iii) upon detection of said one or more characteristics indicative of said initial display text being insufficiently readable by said user, then replacing some or all of said initial display text with further text selected in dependence upon said link data item to provide a modified display text for display on said display device.

12. Apparatus as claimed in claim 11, wherein said data file is retrieved from a source computer server via a computer network.

13. Apparatus as claimed in claim 12, wherein said processing logic is part of a proxy server disposed within said computer network between said source computer server and a client computer requesting said data file.

14. Apparatus as claimed in claim 12, wherein said processing logic is part of a client computer which requests said data file from said source computer server.

15. A computer program storage medium storing a computer program for controlling a data processing apparatus to perform the method as claimed in any one of claims 1 to 10.
